(19) United States
(12) Patent Application Publication
(10) Pub. No.: US 2024/0338938 A1
(43) Pub. Date: Oct. 10, 2024

(54) MULTIMODAL METHOD AND APPARATUS FOR SEGMENTATION AND DEPTH ESTIMATION

(71) Applicant: Harman International Industries, Incorporated, Stamford, CT (US)

(72) Inventors: Andrey Viktorovich FILIMONOV, Rayon, Kamenki (RU); Dmitry Aleksandrovich YASHUNIN, Nizhny Novgorod (RU); Aleksey Igorevich NIKOLAEV, Nizhny Novgorod (RU)

(21) Appl. No.: 18/572,145

(22) PCT Filed: Jun. 28, 2021
(86) PCT No.: PCT/RU2021/000270

§ 371 Date: Dec. 19, 2023

(51) Int. Cl. G06V 10/82; G06T 7/50; G06V 10/26; G06V 10/774; G06V 10/776; G06V 20/58; G06V 20/70

(52) U.S. Cl. CPC G06V 10/82; G06T 7/50; G06V 10/26; G06V 10/774; G06V 10/776; G06V 20/70; G06T 2207/20081; G06T 2207/20084; G06T 2207/30261; G06V 20/58

(57) ABSTRACT

A multimodal neural network model for combined depth estimation and semantic segmentation of images and a method of training the multimodal neural network model. The multimodal neural network comprising a single encoder, a depth decoder to estimate the depth of the image and a semantic segmentation decoder to determine semantic labels from the image. The method for training the multimodal neural network model comprising receiving a plurality of images at a single encoder, after encoding the images providing them to a depth estimation decoder and a semantic segmentation decoder to estimate the depth of the images and semantic labels to the images. The method further comprising comparing the estimated depth with the actual depth of the images and comparing the calculated semantic labels with the actual labels of the images to determine a depth loss and a semantic segmentation loss, respectively.

### FIELD OF DISCLOSURE

The present document generally relates to a multimodal neural network for image segmentation and depth estimation, and a method of training multimodal neural networks. Multimodal neural networks are used to reduce improve the processing speed of neural network models.

### BACKGROUND

With the increased development of technology in the autonomous vehicle industry, it is possible for Advanced Driver Assistance Systems (ADAS) to capture images of a vehicle's surroundings and, with those captured images, to comprehend and understand what is around the vehicle.

Some known examples of comprehending what is around the vehicle include performing semantic segmentation on the images captured by the ADAS. With semantic segmentation, an image is fed into a deep neural network which assigns a label to each pixel of the image based on the object the pixel belongs to. For example, when analysing an image captured by a vehicle in a town centre, the deep neural network of the ADAS may label all of the pixels belonging to cars parked on the side of the road as “car” labels. Similarly, all pixels belonging to the road ahead of the vehicle may be determined as “road” labels, and pixels belonging to the buildings to the side of the vehicle may be determined as “building” labels. The number of different types of labels that can be assigned to a pixel can be varied. Accordingly, a conventional ADAS equipped with semantic segmentation capability can determine what type of objects are located in a vehicle's imminent surrounding (e.g. cars, roads, buildings, trees, etc.). However, a vehicle equipped with such an ADAS arrangement would not be able to determine how far away the vehicle is from the objects located in its imminent surroundings. Furthermore, increasing the number of label types generally leads to a trade-off of increased complexity in processing needs by the ADAS or reduced accuracy in assigning a pixel with the correct label.

Other known examples of comprehending what is around the vehicle include performing depth estimation on the images captured by the ADAS. This involves feeding an image into a different deep neural network which determines the distance from the capturing camera to an object for each pixel of the image. This data can help an ADAS determine how close the vehicle is to objects in its surrounding which, for example, can be useful for preventing vehicle collision. However, a vehicle equipped with depth estimation capabilities would not be able to determine what type of objects are located in the vehicle's imminent surroundings. This can lead to problems during autonomous driving where, for example, the ADAS unnecessarily attempts to prevent a collision with an object in the road (such as a paper bag). Furthermore, the maximum and minimum distances that present ADAS arrangements with depth estimation capabilities can accurately determine the depth is limited to the processing capacity of the ADAS.

Previous attempts at addressing some of these problems include performing both depth estimation and semantic segmentation by an ADAS by providing the ADAS with two separate deep neural networks, the first being capable of performing semantic segmentation and the second being capable of performing depth estimation. For example, state of the art ADAS arrangements capture a first set of images to be fed through a first deep neural network, which performs the semantic segmentation, and capture a second set of images to be fed through a second deep neural network which performs the depth estimation, wherein the two deep neural networks are separate from each other. Therefore, a vehicle equipped with a state of the art ADAS arrangement can determine that an object is close by and, that the object is a car. Accordingly, the vehicle's ADAS can prevent the vehicle from colliding with the car. Furthermore, the vehicle's ADAS could also determine that the object close by (e.g. a paper bag) is not of danger and could accordingly prevent the vehicle from suddenly stopping, thereby preventing a potential collision of the vehicle's behind the vehicle. However, combining two separate deep neural networks in such an arrangement requires a large amount of processing complexity and capacity. Processing complexity and capacity are of utmost value in a vehicle and are determined by the size of the vehicle and its battery capacity.

Accordingly, there is still a need for reducing the amount of components required to perform both semantic segmentation and depth estimation in ADAS arrangements. Furthermore, there still remains the need to improve the accuracy of semantic segmentation (by increasing the number of label types that can accurately be assigned) and depth estimation (by increasing the range at which depth can accurately be measured) while reducing the processing complexity and required capacity of the ADAS.

### SUMMARY

To overcome the problems detailed above, the inventors have devised novel and inventive multimodal neural networks and methods of training multimodal neural networks.

More specifically, claim 1 provides a multimodal neural network for semantic segmentation and depth estimation of a single image (such as an RGB image). The multimodal neural network model comprises an encoder, a depth decoder coupled to the encoder and a semantic segmentation decoder coupled to the encoder. The encoder, depth decoder and semantic segmentation decoder may each be a convolutional neural network. The encoder is operable to receive the single image and forwards the image on to the depth decoder and the semantic segmentation decoder. Following receipt of the image, the depth decoder estimates the depths of the objects in the image (for example, by determining the depth of each pixel of the image). Simultaneously, following receipt of the image, the semantic segmentation decoder determines semantic labels from the image (for example, by assigning a label to each pixel of the image based on the object the pixel belongs to). With the combined estimated depths and determined semantic segmentation from the image, an advanced driver assistance system can perform both depth estimation and semantic segmentation from a single image with reduced processing complexity and, accordingly, a reduced execution time.

The encoder of the neural network model may further comprise a plurality of inverted residual blocks, each operable to perform depthwise convolution of the image. This allows for improved accuracy in encoding the image. Furthermore, the depth decoder and the semantic segmentation decoder may each comprise five sequential upsample bock layers operable to perform depthwise convolution and pointwise convolution on the image received from the image to improve the accuracy of the determined depth estimation and semantic segmentation determination. The multimodal neural network model may comprise at least one skip connection coupling the encoder with the depth decoder and the semantic segmentation decoder. The at least one skip connection may be placed such that it is between two inverted residual blocks of the encoder, between two of the sequential upsample block layers of the depth decoder, and between two of the sequential upsample block layers of the semantic segmentation decoder. This provides additional information from the encoder to the two decoders at different steps of convolution in the encoder, which leads to improved accuracy of results, thereby resulting in reduced processing requirements. Accordingly, processing speed is improved which leads to a reduction in processing complexity by reducing the number of components and processing power required. Preferably, three separate skip connections can be used for a further increase in accuracy of results without impacting the processing complexity of the multimodal neural network model.

A method of training a multimodal neural network for semantic segmentation and depth estimation is set out in claim 10. An encoder of the multimodal neural network receives and encodes a plurality of images. The encoder may be a convolutional neural network and the encoding may comprise performing convolution of the images. The images are sent to a depth decoder and a semantic segmentation decoder, each of which are separately coupled to the encoder and are part of the multimodal neural network. Preferably, at least one skip connection may additionally couple the encoder with both the depth decoder and the semantic segmentation decoder to send the plurality of images at different stages of convolution from the encoder to the decoders, thereby providing improves accuracy of results and reducing processing requirements. After receipt of the images from the encoder, the depth decoder estimates the depths from the images. Subsequently, the estimated depths of the images are compared with the actual depths (which may be supplied from a training set) to calculate a depth loss. The semantic segmentation decoder determines the semantic labels from the images after receipt of the images from the encoder. Following this, the determined semantic segmentation labels of the images are compared with the actual labels of the images (which may be supplied from a training set) to calculate a semantic segmentation loss. To adequately train the multimodal neural network model for improved accuracy and reduced processing speeds the depth loss and segmentation loss are optimised, for example, by adjusting the weight of each layer of the encoder and the decoders such that a total loss is equivalent to 0.02 times the sum of the depth loss and the semantic segmentation loss.

### BRIEF DESCRIPTION OF THE DRAWINGS

FIG. 1 illustrates an example multimodal neural network comprising an encoder, a depth decoder and a semantic segmentation decoder;

FIG. 2 illustrates an exemplary encoder as utilised in the arrangement of FIG. 1;

FIG. 3 illustrates an exemplary depth decoder as utilise in the arrangement of FIG. 1;

FIG. 4 illustrates an exemplary semantic segmentation decoder as utilised in FIG. 1;

FIG. 5 illustrates a prior art approach to depth estimation and semantic segmentation;

FIG. 6 illustrates an improved approach to combined depth estimation and semantic segmentation with reduced processing speeds and improved accuracy of results; and

FIG. 7 is a flow diagram showing the training process of a multimodal neural network model for depth estimation and semantic segmentation.

### DETAILED DESCRIPTION

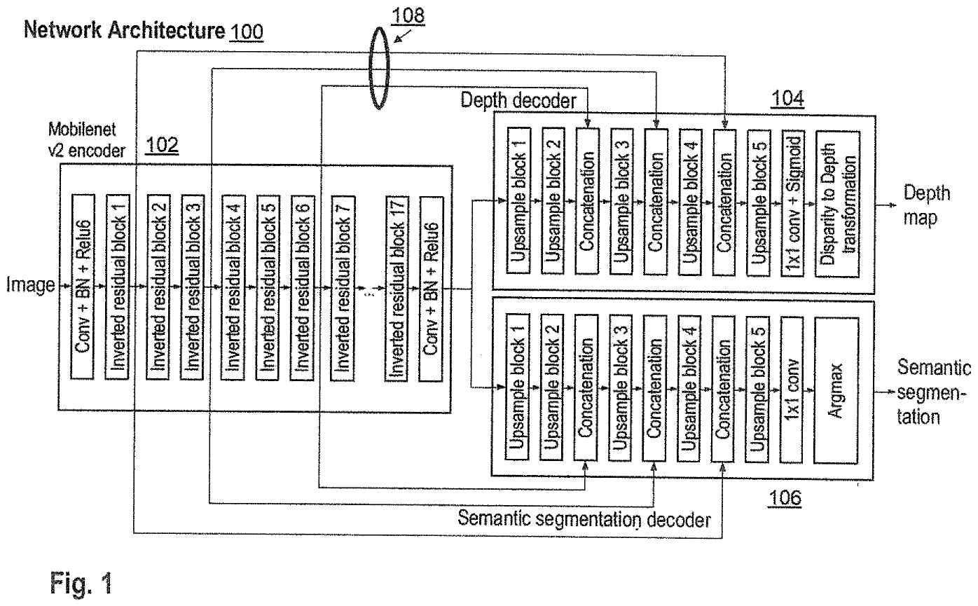

FIG. 1 shows an exemplary multimodal neural network model, NNM, (100) for semantic segmentation and depth estimation of a single image (such as an RGB image for use in Advanced Driver Assistance Systems (ADAS) of vehicles. The NNM (100) of consists of a encoder (102) which receives the image and can perform the initial convolutions on the image, a depth decoder (104) which performs depth estimation of the image, and a semantic segmentation decoder (106) which assigns a semantic label to each pixel of the image. The depth decoder (104) and semantic segmentation decoder (106) are both coupled directly to the encoder (102). In some examples, this coupling may consist of a connection between an output of the encoder (102) and an input of each of the depth decoder (104) and the semantic segmentation decoder (106). Additionally, the encoder (102) may be coupled to both the depth decoder (104) and the semantic segmentation decoder (106) by means of at least one skip connection (108) as is described below in more detail. Advantageously, the multimodal NNM can simultaneously infer the semantic labels and depth estimation from a single image. Furthermore, the use of a single shared encoder reduces the processing complexity which, in turn, helps to reduce execution time.

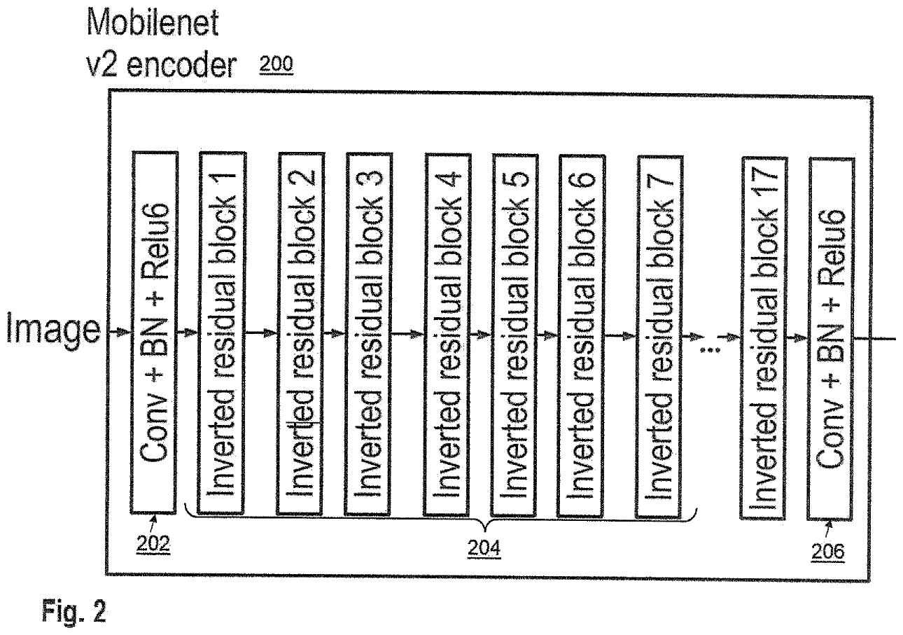

FIG. 2 illustrates an encoder (200) which is identical to the encoder (102) described in FIG. 1. In some examples, the encoder may be a convolutional neural network. A suitable example convolutional neural network suitable may be a Mobilenet V2 encoder, although any suitable convolutional neural network be employed.

The encoder (200) may comprise a first layer (202) operable to receive the image and subsequently perform convolution on the image. Additionally, the first layer (202) may perform a batch normalisation and a non-linearity function on the image. An example of a non-linearity function that may be used is Relu6 mapping. However, it is appreciated that any suitable mapping to ensure non-linearity of the image can be used.

The image input into the encoder (200) may be image data represented in a three-dimensional tensor in the format 3×H×W, where the first channel represents the color channels, H represents the height of the image, and W represents the width of the image.

The encoder (200) may further comprise a second layer (204) following the first layer (202), wherein the second layer (202) comprises a plurality of inverted residual blocks coupled to each other in series. Each of the plurality of inverted residual blocks may perform depthwise convolution of the image. For example, once the image passes through the first layer (202) of the encoder (200), the processed image enters a first one of the plurality of inverted residual blocks which performs depthwise convolution on the image. Following this, that processed image passes through a second one of the plurality of inverted residual blocks which performs a further depthwise convolution on the image. This occurs at each of the plurality of inverted residual blocks, after which the image may pass through a third layer (206) of the encoder (200), the third layer (206) directly following the last of the plurality of inverted residual blocks of the second layer (204). The second layer (204) of the encoder (200) shown in FIG. 2 has a total of 17 inverted residual blocks, however, the actual number of inverted residual blocks is not limited to this number and may be varied depending on the level of accuracy required by the ADAS.

The third layer (206) of the encoder (200) can perform additional convolution on the processed image received from the second layer (204) as well as performing a further batch normalisation function and a further non-linearity function. As with the first layer (202), the non-linearity function may be Relu6 mapping. However, it is appreciated that any suitable mapping to ensure non-linearity of the image can be used.

The features of the encoder (200) may be shared with the depth decoder (104) and semantic segmentation decoder (106) as will be described in more detail below. As a result of this, the model size of the multimodal NNM can be reduced, thereby leading to reduced processing requirements as well as reduced processing complexity. Furthermore, the use of an encoder (200) as described above and in FIG. 2 allows for minimised inference time, which in turn leads to reduced processing complexity and requirements.

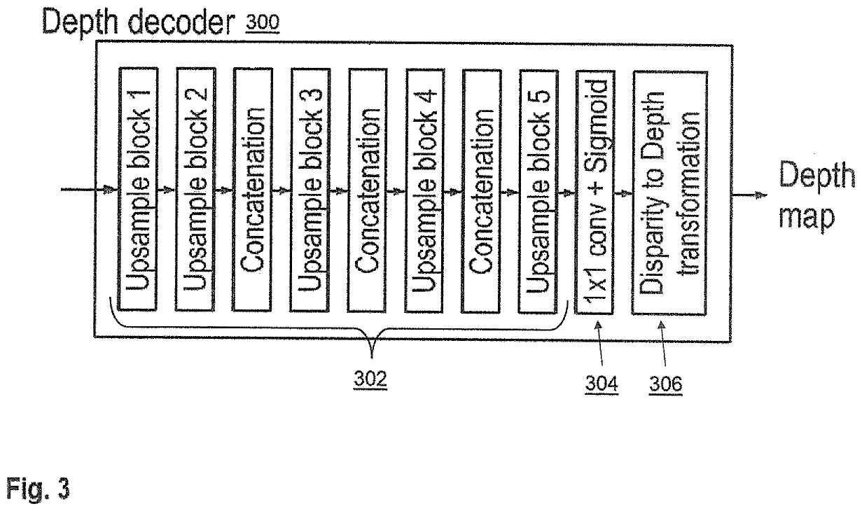

FIG. 3 illustrates a depth decoder (300) which is identical to the depth decoder (104) described in FIG. 1. In some examples, the depth decoder (300) may be a convolutional neural network. A suitable example convolutional neural network suitable may be a FastDepth network, although any suitable convolutional neural network be employed.

The depth decoder (300) may comprise five sequential upsample block layers (302), each operable to perform depthwise convolution and pointwise convolution on the image received from the encoder (102, 200). For example, the third layer (206) of the encoder (200) may be directly coupled to the first sequential upsample block layer (302) of the depth decoder (300), such that the first sequential upsample block layer (302) of the depth decoder receives the image processed by the third layer (206) of the encoder (200). Following depthwise and pointwise convolution at the first sequential upsample block layer (302), the second sequential upsample block layer (302) may then receive the processed image from the first sequential upsample block layer (302). Similarly, the image processed from the second sequential upsample block layer (302) is passed to the third, fourth and fifth sequential upsample block layers (302) in sequence, such that a further level of processing occurs at each of the sequential upsample block layers (302). Each of the five sequential upsample block layers (302) comprise weights which are determined based on the training of the multimodal neural network model.

Following depthwise and pointwise convolution at each of the five sequential upsample block layers (302), the processed image may be sent to a sixth layer (304) of the depth decoder (300). The sixth layer may perform a further pointwise convolution (for example, a 1×1 convolution) on the image as well as an activation function, wherein the activation function can be a sigmoid function. The sigmoid function can be used as an activation function for the depth decoder (300). The network's sigmoid output (disparity) can be converted into depth prediction according to the following nonlinear transformation:

$$depth = {[ \frac{1}{{d}_{max}} + ( \frac{1}{{d}_{min}} - \frac{1}{{d}_{max}} ) * disparity ]}^{- 1} ,$$

where dₘᵢₙ, dₘₐₓ—the minimum and the maximum depth. Examples of dₘᵢₙ, dₘₐₓ values useful for the multimodal neural network model of the ADAS are dₘᵢₙ equal to 0.1 m and dₘₐₓ equal to 60 m. Lower dₘᵢₙ values and higher dₘₐₓ can also be applied to the sigmoid output.

The depth decoder (300) may also comprise a seventh layer (306) directly following the sixth layer, operable to receive the processed image of the sixth layer (306). The seventh layer (306) may comprise logic operable to convert the sigmoid output of the image into a depth prediction of each pixel of the image. In some examples, the logic of the seventh layer (306) comprises a disparity to depth transformation which compiles the depth prediction of each pixel of the image into a response map with the dimension of 1×H×W, where H is the height of the output image and W is the width of the output image.

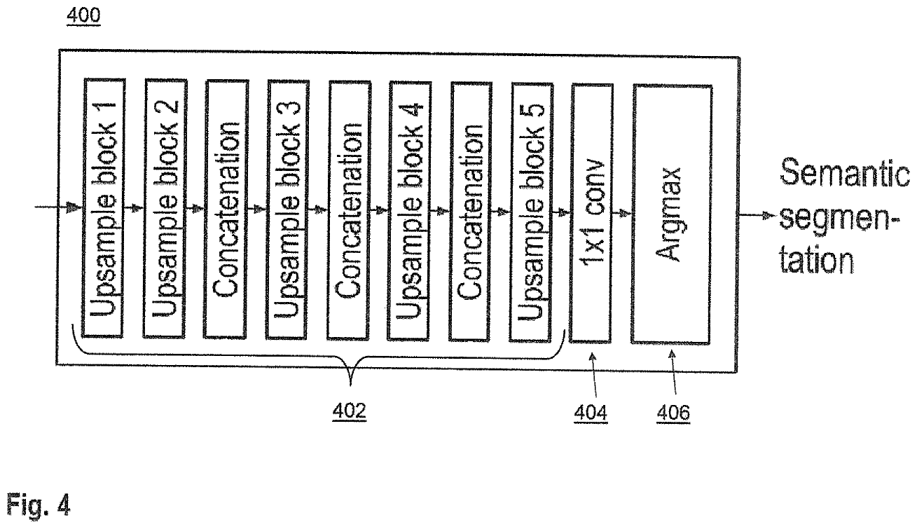

FIG. 4 illustrates a semantic segmentation decoder (400) which is identical to the semantic segmentation decoder (106) described in FIG. 1. In some examples, the semantic segmentation decoder (400) may be a convolutional neural network. A suitable example convolutional neural network suitable may be a FastDepth network, although any suitable convolutional neural network be employed.

The semantic segmentation decoder (400) may comprise five sequential upsample block layers (402), each operable to perform depthwise convolution and pointwise convolution on the image received from the encoder (102, 200). For example, the third layer (206) of the encoder (200) may be directly coupled to the first sequential upsample block layer (402) of the semantic segmentation decoder (400), such that the first sequential upsample block layer (402) of the semantic segmentation decoder (400) receives the image processed by the third layer (206) of the encoder (200). Following depthwise and pointwise convolution at the first sequential upsample block layer (402), the second sequential upsample block layer (402) may then receive the processed image from the first sequential upsample block layer (402). Similarly, the image processed from the second sequential upsample block layer (402) is passed to the third, fourth and fifth sequential upsample block layers (402) in sequence, such that a further level of processing occurs at each of the sequential upsample block layers (402). Each of the five sequential upsample block layers (402) comprise weights which are determined based on the training of the multimodal neural network model.

Following depthwise and pointwise convolution at each of the five sequential upsample block layers (402), the processed image may be sent to a sixth layer (404) of the semantic segmentation decoder (400). The sixth layer may perform a further pointwise convolution (for example, a 1×1 convolution) on the image, wherein that pointwise convolution leads to the processed image corresponding to a score map with the dimension of C×H×W, where C is the number of semantic classes, H is the height of the processed image, and W is the width of the processed image.

The semantic segmentation decoder (400) may also comprise a seventh layer (406) directly following the sixth layer (404), operable to receive the processed image of the sixth layer (404). The seventh layer (406) may comprise logic operable to receive the score map from the sixth layer (404) and to determine segments of the image by taking an arg max of each score pixel vector of the image.

Returning to FIG. 1, the encoder (102, 200) may be coupled to both the depth decoder (104, 300) and the semantic segmentation decoder (106, 400) by means of at least one skip connection (108) as is briefly discussed above. More specifically, a skip connection may be placed such that it is between two of the plurality of inverted residual blocks (204) of the encoder (102, 200), between two of the sequential upsample block layers (302) of the depth decoder (104, 300), and between two of the sequential upsample block layers (402) of the semantic segmentation decoder (106, 400). Accordingly, a partially processed image can be directly sent from any one of the inverted residual blocks of the encoder to any one of the upsample block layers of the depth decoder and semantic segmentation decoder (for example, by concatenation). This allows for an alternate path of estimating depth and determining semantic labels of an image. Utilising such an alternate pass can bypass multiple layers of the multimodal neural network model. Accordingly, less processing power is required to estimate the depth of the image and to determine semantic labels of the image.

Although only one skip connection (108) is described above, more than one skip connection (108) may be employed to couple the encoder (102, 200) with both the depth decoder (104, 300) and the semantic segmentation decoder (106, 400). Preferably three skip connections may be employed, as illustrated in FIG. 1, to provide a more accurate determination of depth and semantic segmentation.

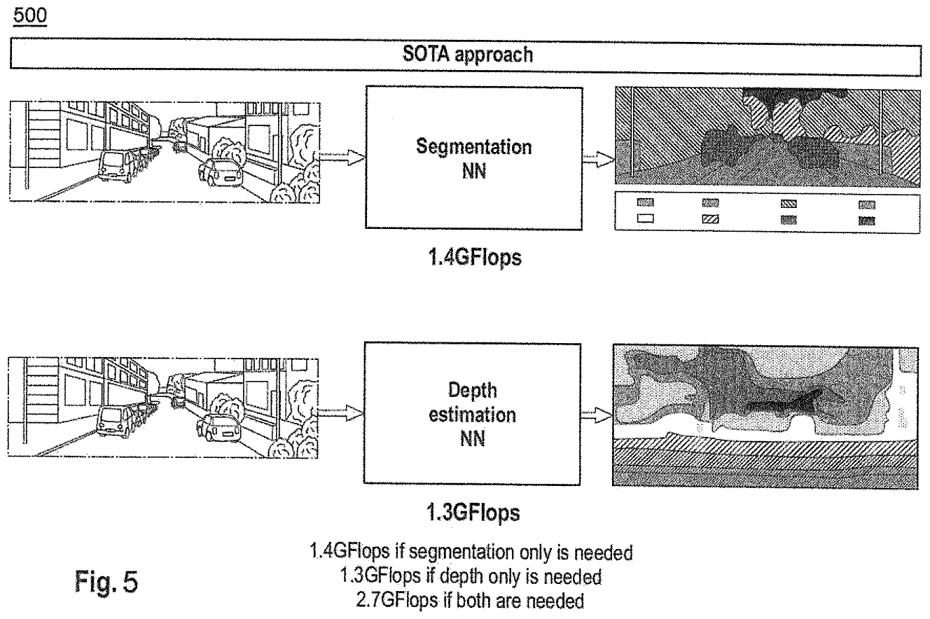

FIG. 5 illustrates present solutions to the problem of obtaining both depth estimation and semantic segmentation with the use of neural networks. When considering a typical state of the art (SOTA) approach which may, for example, comprise an input resolution of a 512×288 image, two separate neural networks are required for semantic segmentation and for depth estimation (one for each of those functions). Typically, this means that each of those neural networks will require both an encoder and a decoder which leads to substantial processing complexity and limits the capacity of a typical ADAS to decrease the tolerances when analysing images. With such an arrangement, a plurality of images (at least two, one for depth estimation and one for semantic segmentation) are required to perform both depth estimation and semantic segmentation as opposed to a single image being used in the present multimodal neural network model. As can be seen in FIG. 5, the SOTA approach typically requires a processing capacity of 1.4 GFlops for semantic segmentation, and a processing capacity of 1.3 GFlops for depth estimation. If both semantic segmentation and depth estimation are required, the combined processing requirements amount to 2.7 GFlops in the state of the art approach.

Furthermore, a typical SOTA approach of semantic segmentation with an input resolution if 512×288, as described above with reference to FIG. 5, may comprise an aver intersection of union (IoU) of 0.39 and an average IoU of determining a road of 0.94. With reference to depth estimation, the SOTA approach of FIG. 5 may only have an average mean absolute error (MAE) of 2.35 metres, and an average MAE on the road of 0.75 metres.

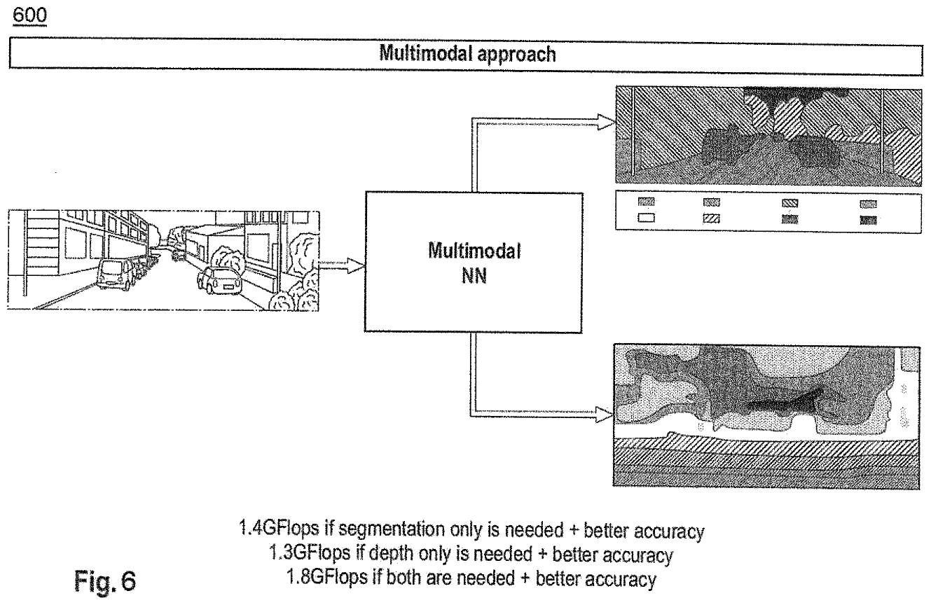

FIG. 6 illustrates an exemplary solution to the problems posed by the SOTA approach in FIG. 5. The approach shown in FIG. 6 may be achieved by employing the multimodal neural network model as described above in relation to FIGS. 1 to 4 in an ADAS. With the arrangement in FIG. 6, only one image needs to be fed into the multimodal neural network model, which can perform both semantic segmentation and depth estimation. This leads to a reduction in processing requirements such that combined depth estimation and semantic segmentation only require 1.8 GFlops.

If only semantic segmentation or depth estimation is required, the processing requirements remain the same at 1.4 GFlops and 1.3 GFlops, respectively. However, utilising a unified encoder-decoder arrangement (i.e. only one shared encoder being required) as described in FIGS. 1 to 4 allows for an increase in accuracy, such that for semantic segmentation the Average IoU may be increased to 0.48 and the average IoU of determining a road can be increased to 0.96. With regard to depth estimation, the accuracy can also be increased with the arrangement as described in FIGS. 1 to 4, such that the average MAE is reduced to just 2.02 m and the average MAE on the road is reduced to 0.52 m. The increased accuracies may also achieved when performing both semantic segmentation and depth estimation.

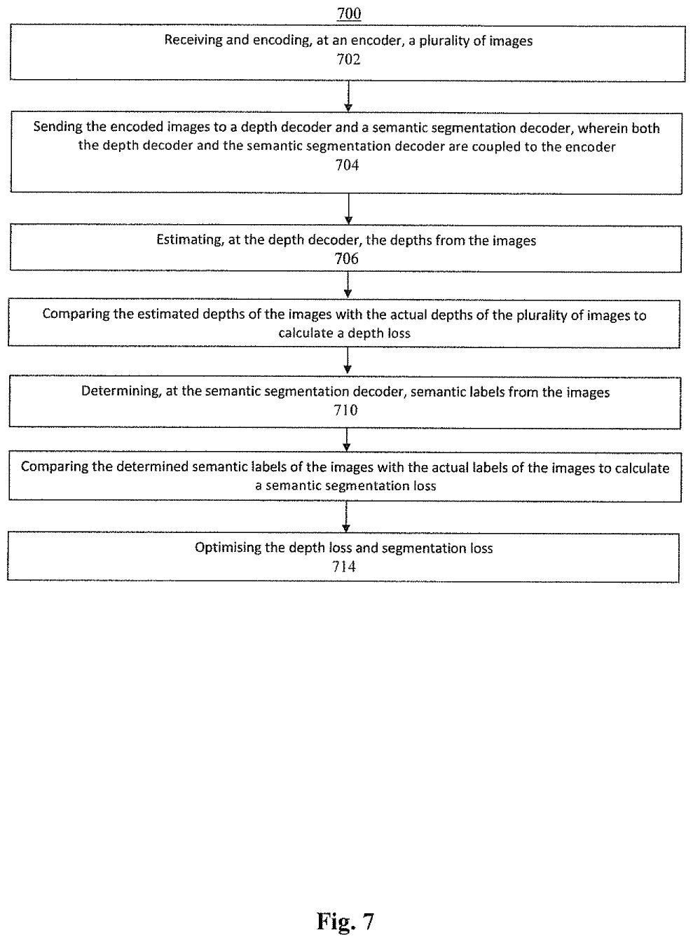

FIG. 7 illustrates a flow diagram (700) of a method of training a multimodal neural network as described above in relation to FIGS. 1 to 4, and 6 for accurate semantic segmentation and depth estimation. At step 702, the encoder (such as the encoder of FIG. 2) of the multimodal neural network receives and encodes a plurality of images. The encoded images are sent, at step 704, to a depth decoder (such as the depth decoder of FIG. 3) and a semantic segmentation decoder (such as the semantic segmentation decoder of FIG. 4), wherein both the depth decoder and the semantic segmentation decoder are coupled to the encoder. At step 706, the depth decoder estimates the depths from the images. At step 708, the estimated depths of the images are compared with the actual depths of the plurality of images to calculate a depth loss. At step 710, semantic labels are determined from the images at the semantic segmentation decoder. At step 712, the determined semantic labels of the images are compared with the actual labels of the images to calculate a semantic segmentation loss. Finally, at step 714, the depth loss and segmentation loss are optimised to ensure accurate results can be achieved when the multimodal neural network model has been trained and is in full operation in an ADAS.

The plurality of images received by the encoder may be training images used to successfully train the multimodal neural network model. In some arrangements, NuScenes and Cityscapes datasets can be used for training the model. However, the present arrangements are not limited to these datasets and other datasets may be used to train the multimodal neural network model. Cityscapes dataset contains front camera images and semantic labels for all images. NuScenes dataset contains front camera images and lidar data. A projection (using Pinhole camera) of lidar points to camera images to get sparse depth maps can further be utilised. To supplement the fact that NuScenes dataset doesn't have semantic labels an additional training set, such as HRNet semantic segmentation predictions, can be utilised as a ground truth for this training dataset. A preferred combined training set of NuScenes and Cityscapes dataset can be split into train and test sets with a total size of training set being 139536 images. PyTorch may be used as an exemplary application to train the multimodal neural network model. However, the present arrangements are not limited to this application and other applications may be used to train the multimodal neural network model.

Optimising the segmentation loss and the depth loss during training may further comprise optimising such that

$$L = 0.02 * {L}_{depth} + {L}_{segm} ,$$

where L_{depth} is the depth loss, and L_{segm} is the semantic segmentation loss. The semantic segmentation loss L_{segm} may be a pixel-wise categorical cross-entropy loss. The depth loss L_{depth} may be a pixel-wise mean sum of squares loss (MSE).

During training of the multimodal neural network model, each of the five sequential upsample block layers of the depth decoder and each of the five sequential upsample block layers of the semantic segmentation decoder (as described in FIGS. 3 and 4) may comprise weights initialised at random, and optimising the depth loss and segmentation loss may comprise adjusting the weights of each layer (of each decoder) separately.

To perform accurate training, the multimodal neural network model may be trained for 30 epochs using an Adam optimizer with learning rate 1e-4 and parameter values β1=0.9, β2=0.999. The batch size can be equal to 12 and the StepLR learning rate scheduler can be used with 10 epochs learning rate decay. The network encoder may be pretrained on ImageNet and the decoder weights can be initialized randomly, as discussed above.

During training, images in the training set can be shuffled and resized to 288 by 512. Training data augmentation can be done by horizontal flipping of images at a probability of 0.5 and by performing each of the following image transformations with 50% chance: random brightness, contrast, saturation, and hue jitter with respective ranges of +0.2, +0.2, +0.2, and +0.1.

1. A multimodal neural network model, NNM, comprising:
an encoder operable to receive an image;
a depth decoder coupled to the encoder operable to estimate depth from the image; and
a semantic segmentation decoder coupled to the encoder operable to determine semantic labels from the image.

2. The multimodal NNM of claim 1, wherein the encoder is a convolutional neural network comprising:
a first layer operable to receive the image and subsequently perform convolution, batch normalisation and a non-linearity function on the image;
a second layer following the first layer, the second layer comprising a plurality of inverted residual blocks each operable to perform depthwise convolution on the image; and
a third layer following the second layer, the third layer operable to perform convolution, batch normalisation and non-linearity functions on the image.

3. The multimodal NNM of claim 2, wherein the non-linearity function is Relu6.

4. The multimodal NNM of claim 2, wherein the depth decoder is a convolutional neural network comprising:
five sequential upsample block layers, each of the five sequential upsample block layers operable to perform depthwise convolution and pointwise convolution on the image received from the encoder;
a sixth layer following the five sequential upsample block layers, the sixth layer operable to perform a further pointwise convolution and a sigmoid function on the image; and
a seventh layer comprising logic operable to convert the sigmoid output of the image into a depth prediction.

5. The multimodal NNM of claim 2, wherein the semantic segmentation decoder is a convolutional neural network comprising:
five sequential upsample block layers, each of the five sequential upsample block layers operable to perform depthwise convolution and pointwise convolution on the image received from the encoder;
a sixth layer following the five sequential upsample block layers, the sixth layer operable to perform a further pointwise convolution on the image; and
a seventh layer comprising logic operable to receive a score map from the sixth layer and subsequently to determine segments of the image by taking an arg max of each score pixel vector of the image.

6. The multimodal NNM of claim 5, further comprising at least one skip connection coupling the encoder with the depth decoder and the semantic segmentation decoder such that the at least one skip connection is placed:
between two of the plurality of inverted residual blocks of the encoder;
between two of the sequential upsample block layers of the depth decoder; and
between two of the sequential upsample block layers of the semantic segmentation decoder.

7. The multimodal NNM of claim 2, wherein the image is a three-dimensional tensor with an input shape of 3×H×W, wherein 3 represents the dimension, H represents the height, and W represents the width of the image.

8. The multimodal NNM of claim 7, wherein the semantic segmentation decoder outputs a score map with the dimension of C×H×W, wherein C represents the number of semantic classes.

9. The multimodal NNM of claim 7, wherein the depth estimation decoder outputs a response map with the dimension of 1×H×W.

10. A method of training a multimodal neural network model, NNM, for semantic segmentation and depth estimation comprising:
receiving and encoding, at an encoder, a plurality of images;
sending the encoded images to a depth decoder and a semantic segmentation decoder, wherein both the depth decoder and the semantic segmentation decoder are coupled to the encoder;
estimating, at the depth decoder, the depths from the images;
comparing the estimated depths of the images with the actual depths of the plurality of images to calculate a depth loss;
determining, at the semantic segmentation decoder, semantic labels from the images;
comparing the determined semantic labels of the images with the actual labels of the images to calculate a semantic segmentation loss; and
optimising the depth loss and segmentation loss.

11. The method of claim 10, wherein the encoder is a convolutional neural network comprising:
a first layer operable to receive the image and subsequently perform convolution, batch normalisation and a non-linearity function on the images;
a second layer following the first layer, the second layer comprising a plurality of inverted residual blocks each operable to perform depthwise convolution on the images; and
a third layer following the second layer, the third layer operable to perform convolution, batch normalisation and non-linearity functions on the images.

12. The method of claim 11, wherein:
the depth decoder is a convolutional neural network comprising:
five sequential upsample block layers, each of the five sequential upsample block layers operable to perform depthwise convolution and pointwise convolution on the image received from the encoder;
a sixth layer following the fifth layer, the sixth layer operable to perform a further pointwise convolution and a sigmoid function on the image;
a seventh layer comprising logic operable to convert the sigmoid output of the image into a depth prediction; and
the semantic segmentation decoder is a convolutional neural network comprising:
five sequential upsample block layers, each of the five sequential upsample block layers operable to perform depthwise convolution and pointwise convolution on the image received from the encoder;
a sixth layer following the fifth layer, the sixth layer operable to perform a further pointwise convolution on the image; and
a seventh layer comprising logic operable to receive a score map from the sixth layer and subsequently to determine segments of the image by taking an ar gmax of each score pixel vector of the image.

13. The method of claim 12, wherein at least one skip connection couples the encoder with the depth decoder and the semantic segmentation decoder such that the at least one skip connection is placed:
between two of the plurality of inverted residual blocks of the encoder;
between two of the sequential upsample block layers of the depth decoder; and
between two of the sequential upsample block layers of the semantic segmentation decoder.

14. The method of claim 12, wherein each of the five sequential upsample block layers of the depth decoder and each of the five sequential upsample block layers of the semantic segmentation decoder comprise weights initialised at random; and wherein optimising the depth loss and segmentation loss comprises adjusting the weight of each layer separately.

15. The method of claim 10, wherein the depth loss and segmentation loss is optimised such that total loss is equivalent to 0.02 times the sum of the depth loss and the semantic segmentation loss.
